(19) United States
(12) Patent Application Publication
(10) Pub. No.: US 2007/0017560 A1
(43) Pub. Date: Jan. 25, 2007

(54) Substrate carrier

(75) Inventor: Kenji Kiyota, Koshi-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Minato-ku (JP)

(21) Appl. No.: 11/484,566

(22) Filed: Jul. 12, 2006

(30) Foreign Application Priority Data
Jul. 25, 2005 (JP) 2005-214609

(51) Int. Cl. B08B 3/00

(52) U.S. Cl. 134/137

(57) ABSTRACT

The present invention includes a plurality of carrier arms provided close to each other, each of the carrier arms for supporting a substrate and carrying the substrate in the horizontal direction. The plurality of carrier arms are arranged such that carriage paths thereof overlap one on the other in plan view, each of the paths for carrying-in/out the substrate to/from a processing unit or a substrate housing cassette, and each of the plurality of carrier arms is independently movable in the vertical direction and is capable of passing the other in the vertical direction without interfering with each other. According to the present invention, in the carrier including the plurality of carrier arms, the degrees of freedom of the carrier arms are increased to improve the substrate carriage efficiency.

### BACKGROUND OF THE INVENTION

1. Field of the Invention

The present invention relates to a substrate carrier.

2. Description of the Related Art

In a photolithography process, for example, in a manufacturing process of a semiconductor device, a plurality of treatments and processing are continuously performed such as a resist coating treatment of applying a resist solution to a substrate such as a wafer, a developing treatment of developing the substrate after exposure, thermal processing of heating and cooling the substrate, and so on.

In the above-described plurality of treatments and processing are generally performed in a coating and developing treatment system. The coating and developing treatment system includes, for example, a cassette station in which cassettes each capable of housing a plurality of substrates are mounted; a processing station in which various kinds of treatment and processing units are arranged which perform the resist coating treatment, the developing treatment, the thermal processing and so on for the substrate; and an interface section for carrying-in/out the substrate to/from an aligner adjacent thereto. Carriage of the substrate in the coating and developing treatment system is performed by a plurality of substrate carriers.

As a conventional substrate carrier, a substrate carrier is used which includes a plurality of carrier arms for supporting and carrying the substrate provided in a cylindrical support rotatable, for example, about the vertical axis (Japanese Patent Application Laid-open No. Hei 8-46010). The carrier arms of the substrate carrier are attached to the same base and can move in the forward and backward direction on the base. Further, a rising and lowering mechanism is attached to the base, so that each of the carrier arms can move in the vertical direction by means of the base. The cylindrical support determines the carriage direction of the carrier arm, the base determines the height of the carrier arm, and the carrier arm then moves in the forward and backward direction to carry the substrate.

However, since the above-described conventional substrate carrier has a plurality of arms placed one above the other in the vertical direction, and the carrier arms are moved in the vertical direction as one body, the movement of each of the carrier arms is limited by the movement of the other carrier arm. For example, while one of the carrier arms is operating to carry the substrate, the orientation and the height of the other carrier arm are also determined, whereby the moving range of the other carrier arm is limited. As described above, the degrees of freedom of movements of the carrier arms are low, thus complicating, for example, the control to determine the order of movements of the carrier arms for efficiently carrying a plurality of substrates in the coating and developing treatment system. Furthermore, there is a limit to increasing the substrate carriage efficiency.

### SUMMARY OF THE INVENTION

The present invention has been developed in consideration of the above viewpoints, and its object is, in a substrate carrier including a plurality of carrier arms, to increase the degrees of freedom of movements of the carrier arms.

A carrier for carrying a substrate of the present invention to achieve the above object includes: a plurality of carrier arms provided close to each other, each of the carrier arms for supporting the substrate and carrying the substrate in the horizontal direction, wherein the plurality of carrier arms are arranged such that carriage paths thereof overlap one on the other in plan view, each of the paths for horizontally carrying-in/out the substrate to/from a processing unit or a substrate housing cassette, and wherein each of the plurality of carrier arms is independently movable in the vertical direction and is capable of passing the other in the vertical direction at a position on the carriage path.

According to the present invention, since each of the carrier arms is independently vertically movable and each of the plurality of carrier arms is capable of passing the other, the degrees of freedom of the movements of the carrier arms are increased. Therefore, the control of the plurality of carrier arms to determine the order of their movements can be simplified. Further, the substrate carriage efficiency can also be improved.

The carrier arm may include a substrate support portion for supporting the substrate, and in this case the carrier arm may move the substrate support portion in a forward and backward direction on the carriage path of the substrate to carry-in/out the substrate to/from the processing unit or the substrate housing cassette, wherein when the substrate support portion of one of the carrier arms moves forward, a space is formed on the backside of the substrate support portion of the one carrier arm, through the space the other carrier arm being capable of passing in the vertical direction. In this case, while the substrate support portion of one of the carrier arms is carrying-in/out the substrate to/from the processing unit or the substrate housing cassette, the other carrier arm may pass through the space to pass the one carrier arm in the vertical direction.

The substrate support portions of the carrier arms may be configured such that the substrate support portions supporting no substrate are capable of passing each other in the vertical direction without interfering with each other at a same position on the carriage paths in plan view, each of the paths for carrying-in/out the substrate to/from the processing unit or the substrate housing cassette.

In the case where the carrier of the present invention includes two carrier arms, the substrate support portion may include a base portion extending in the forward and backward direction and a plurality of projecting portions projecting in one direction from a side surface of the base portion, the plurality of projecting portions may be provided having gaps intervening therebetween on the side surface of the base portion, the substrate support portions of the carrier arms may be arranged such that the projecting portion sides face each other in plan view, and when passing each other in the vertical direction, the projecting portions of one of the substrate support portions may pass through the gaps between the projecting portions of the other substrate support portion.

In the present invention, the carrier arms may be attached to discrete rising and lowering shafts for vertically moving the carrier arms.

Each of the carrier arms may have an arm portion connecting the substrate support portion and the rising and lowering shaft, and the arm portion may be curved convexly outward in a direction perpendicular to the forward and backward direction in which the substrate support portion moves in plan view.

The rising and lowering shafts of the carrier arms may be attached to a same rotary table rotatable around an axis in the vertical direction. The rotary table may be movable in the horizontal direction. In this case, the carrier arms may be arranged at positions symmetrical with respect to a carriage axis passing through the rotation axis of the rotary table and the carriage paths.

According to the present invention, the degrees of freedom of movements of the carrier arms are increased to improve the substrate carriage efficiency, resulting in an improved throughput. Further, the control of the movements of the carrier arms can be simplified.

### BRIEF DESCRIPTION OF THE DRAWINGS

FIG. 1 is a plan view showing the outline of a configuration of a substrate processing system equipped with a carrier according to an embodiment of the present invention;

FIG. 2 is a side view showing the outline of the configuration of the substrate processing system in FIG. 1;

FIG. 3 is a rear view showing the outline of the configuration of the substrate processing system in FIG. 1;

FIG. 4 is an explanatory view showing a moving mechanism of solution treatment units in a second block;

FIG. 5 is an explanatory view showing moving directions of the units in first to third blocks;

FIG. 6 is a perspective view showing the outline of a configuration of a carrier according to the embodiment of the present invention;

FIG. 7 is a plan view showing the outline of the configuration of the carrier in FIG. 6;

FIG. 8 is an explanatory view of a longitudinal section of a wafer support portion of a carrier arm in the embodiment of the present invention;

FIG. 9 is a plan view of the carrier showing a state when one carrier arm passes the other;

FIG. 10 is an explanatory view explaining an appearance in which one carrier arm passes the other;

FIG. 11 is an explanatory view explaining an appearance in which one carrier arm passes the other; and

FIG. 12 is a plan view showing the outline of a configuration of another substrate processing system in which the carrier of the present invention can be installed.

### DETAILED DESCRIPTION OF THE PREFERRED EMBODIMENT

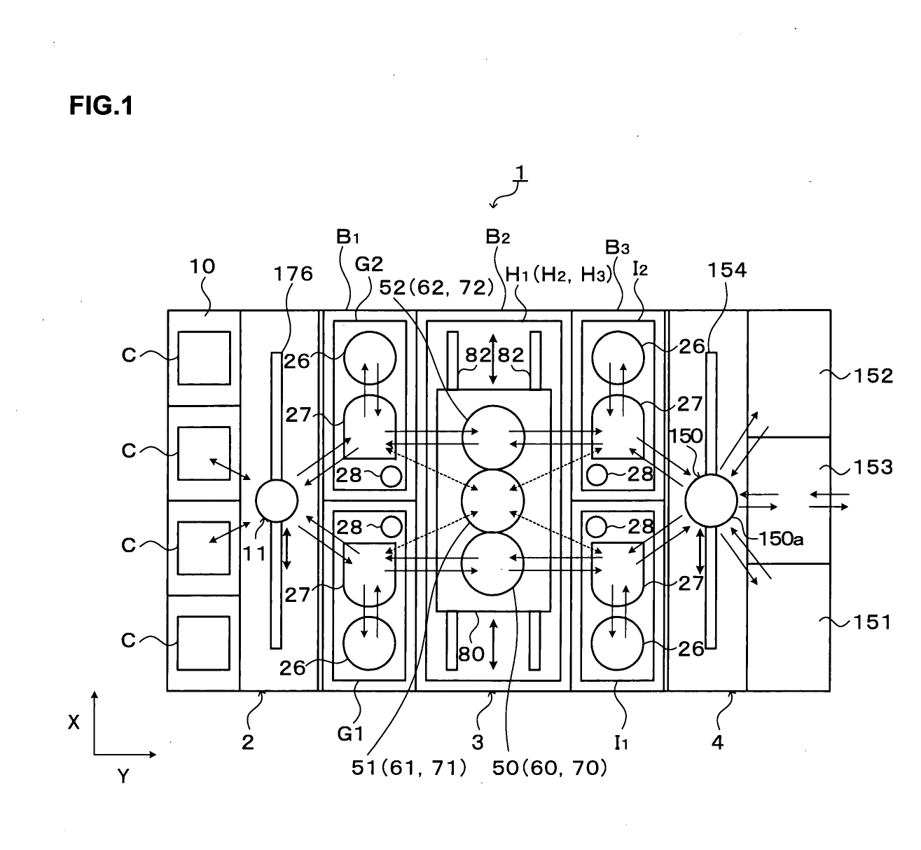

Hereinafter, a preferred embodiment of the present invention will be described. FIG. 1 is a plan view showing the outline of a configuration of a substrate processing system 1 equipped with a substrate carrier according to this embodiment.

The substrate processing system 1 has, as shown in FIG. 1, a configuration in which, for example, a cassette station 2 for carrying, for example, 25 wafers W per cassette as a unit from/to the outside into/from the substrate processing system 1 and carrying the wafers W into/out of cassettes C; a processing station 3 provided adjacent to the cassette station 2 and including a plurality of units for performing various kinds of processing or treatments in the photolithography process; and an interface section 4 for transferring the wafers W to/from an aligner (not shown) provided adjacent to the processing station 3, are integrally connected together. The cassette station 2, the processing station 3, and the interface section 4 are connected in series in a Y-direction (a right-to-left direction in FIG. 1).

In the cassette station 2, a cassette mounting table 10 is provided on which a plurality of cassettes C can be mounted in an X-direction (a top-to-bottom direction in FIG. 1). The cassette C can house a plurality of wafers W arranged in the vertical direction. On the processing station 3 side in the cassette station 2, a carrier 11 according to the embodiment of the present invention is provided which carries the wafer W between the cassette C and the processing station 3. The configuration of the carrier 11 will be described later in detail.

The processing station 3 adjacent to the cassette station 2 includes, for example, three blocks B1, B2, and B3 each including a plurality of units. In the processing station 3, for example, the first block B1, the second block B2, and the third block B3 are arranged side by side in this order from the cassette station 2 side toward the interface section 4 side.

In the first block B1, for example, two unit groups G1 and G2 are located which are arranged side by side, for example, along the X-direction.

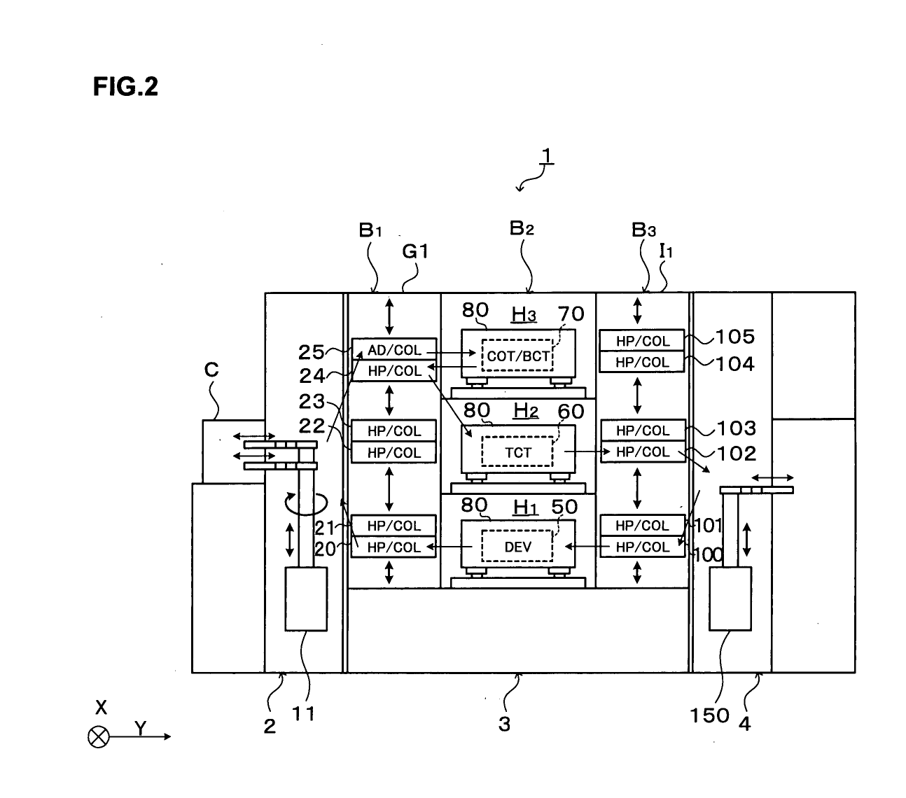

As shown in FIG. 2, in the first unit group G1, for example, a plurality of thermal processing units are tiered. In the first unit group G1, for example, heating/cooling units 20, 21, 22, 23, and 24 each for performing heating processing and cooling processing for the wafer W and an adhesion/cooling unit 25 for performing adhesion treatment and cooling processing for the wafer W are six-tiered in order from the bottom. Each of the thermal processing units 20 to 25 has, as shown in FIG. 1, a heating plate 26 and a cooling plate 27 which can transfer the wafer W to/from each other, so that both heating and cooling of the wafer W can be performed consecutively. Each of the thermal processing units 20 to 25 has a wafer carrier 28 which can carry the wafer W, for example, between the cooling plate 27 and a later-described unit in the second block B2. Note that the adhesion/cooling unit 25 further includes a supply port for supplying vapor of an adhesion promoter for enhancing the adhesion of a resist solution into the processing chamber and an exhaust port for exhausting an atmosphere in the processing chamber.

As shown in FIG. 2, for example, two units adjacent in the vertical direction, that is, the heating/cooling units 20 and 21, the heating/cooling units 22 and 23, and the heating/cooling unit 24 and the adhesion/cooling unit 25 are integrated in pairs respectively. Each pair of units, upper and lower units, can move in pairs in the vertical direction.

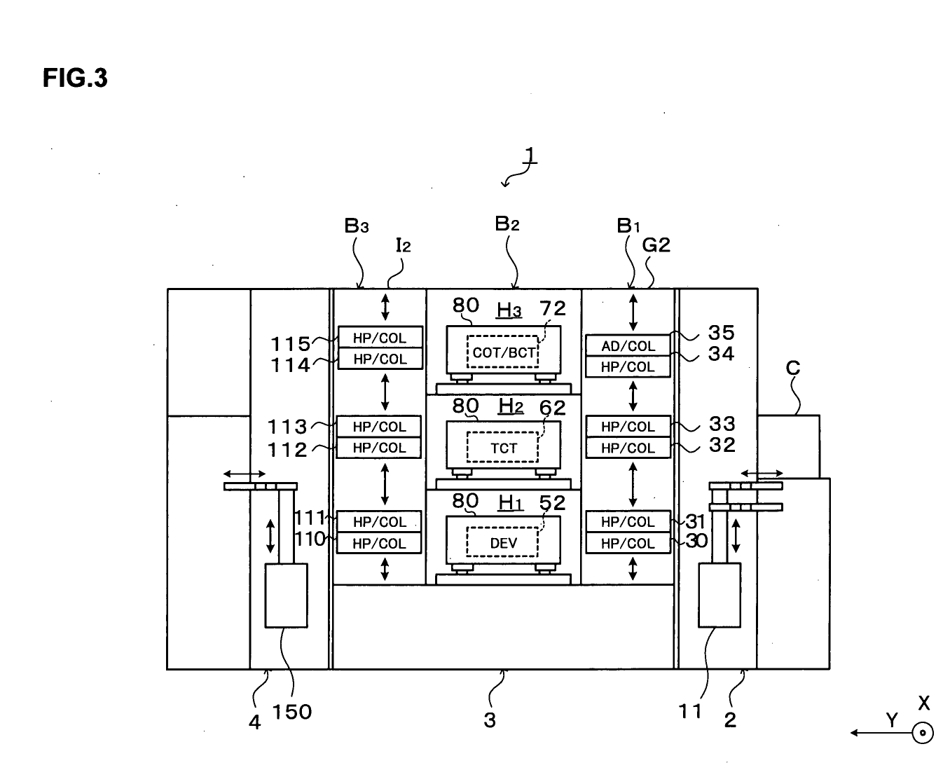

In the second unit group G2, for example, heating/cooling units 30, 31, 32, 33, and 34 and an adhesion/cooling unit 35 are six-tiered in order from the bottom, as shown in FIG. 3, as in the first unit group G1. These thermal processing units have, for example, the same configurations as those in the first unit group G1.

In the second block B2 of the processing station 3, as shown in FIG. 2, for example, three unit layers H1, H2, and H3 are arranged which are tiered in the vertical direction. In each of the unit layers H1 to H3, a plurality of solution treatment units are provided each for performing solution treatment for the wafer W.

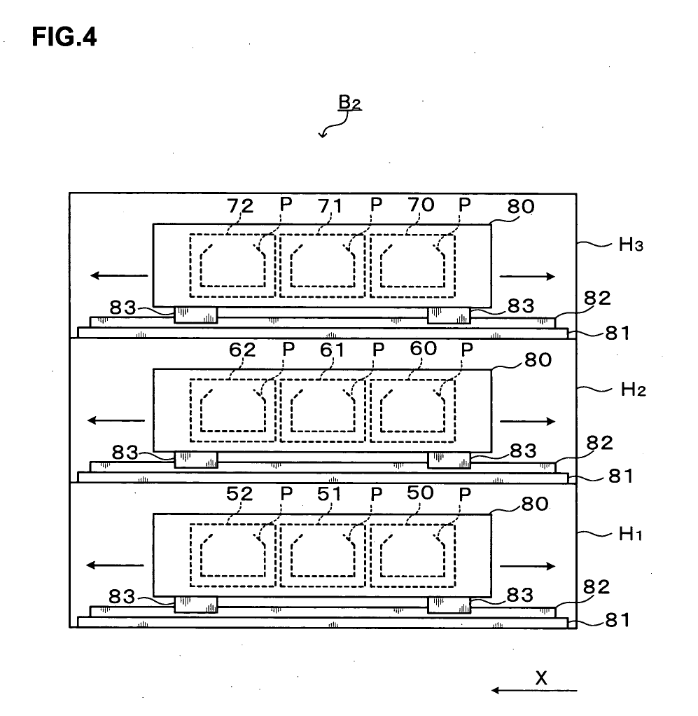

For example, as shown in FIG. 4, in the first unit layer H1 at the lowermost tier, developing treatment units 50, 51, and 52 each for supplying a developing solution to the wafer W to perform developing treatment are provided side by side in the horizontal direction in the X-direction. In the second unit layer H2 at the intermediate tier, for example, top coating units 60, 61, and 62 each for forming an antireflection film on top of the resist film are provided side by side in the horizontal direction in the X-direction. In the third unit layer H3 at the uppermost tier, for example, a resist coating unit 70 for applying the resist solution onto the wafer W, a bottom coating unit 71 for forming an antireflection film at the bottom of the resist film, and a resist coating unit 72 are provided side by side in the horizontal direction in the X-direction. In each of the solution treatment units in the second block B2, a cup P is provided for housing the wafer W and preventing a solution from scattering.

The developing treatment units 50 to 52 in the first unit layer H1 are housed, for example, in one housing 80 as shown in FIG. 4. The housing 80 is mounted, for example, on rails 82 formed in the X-direction on a base 81. The housing 80 is movable on the rails 82, for example, by drive mechanisms 83. This allows the developing treatment units 50 to 52 in the first unit layer H1 to move in the horizontal direction in the X-direction with respect to the thermal processing units in the adjacent first block B1 and third block B3 as shown in FIG. 1. Note that, on both sides in the Y-direction of the housing 80, carry-in/out ports (not shown) for the wafers W are formed.

As shown in FIG. 4, each of the second unit layer H2 and the third unit layer H3 also has the same configuration as that of the first unit layer H1, in which the plurality of solution treatment units in each of the second unit layer H2 and the third unit layer H3 are housed in a housing 80 and can move horizontally in the X-direction on rails 82 by means of a drive mechanism 83.

In the third block B3 of the processing station 3, two unit groups I1 and 12 are provided which are arranged side by side in the X-direction. In each of the unit groups I1 and I2, for example, a plurality of thermal processing units as third units are tiered.

For example, in the first unit group I1, as shown in FIG. 2, heating/cooling units 100, 101, 102, 103, 104, and 105 are six-tiered in order from the bottom. For example, in the second unit group I2, as shown in FIG. 3, heating/cooling units 110, 111, 112, 113, 114, and 115 are six-tiered in order from the bottom.

Each of the heating/cooling units 100 to 105 and 110 to 115 in the first unit group I1 and the second unit group I2 has the same configuration as that of the above-described heating/cooling unit 20 in the first block B1, and thus includes a heating plate 26, a cooling plate 27 and a wafer carrier 28. The wafer carrier 28 can carry the wafer W between each of the heating/cooling units in the unit groups I1 and I2 and the solution treatment unit in the second block B2.

The heating/cooling units in the unit groups I1 and 12 are integrated such that every two units adjacent in the vertical direction are integrated in a pair as shown in FIG. 2 and FIG. 3, and each pair of units can move in pairs in the vertical direction.

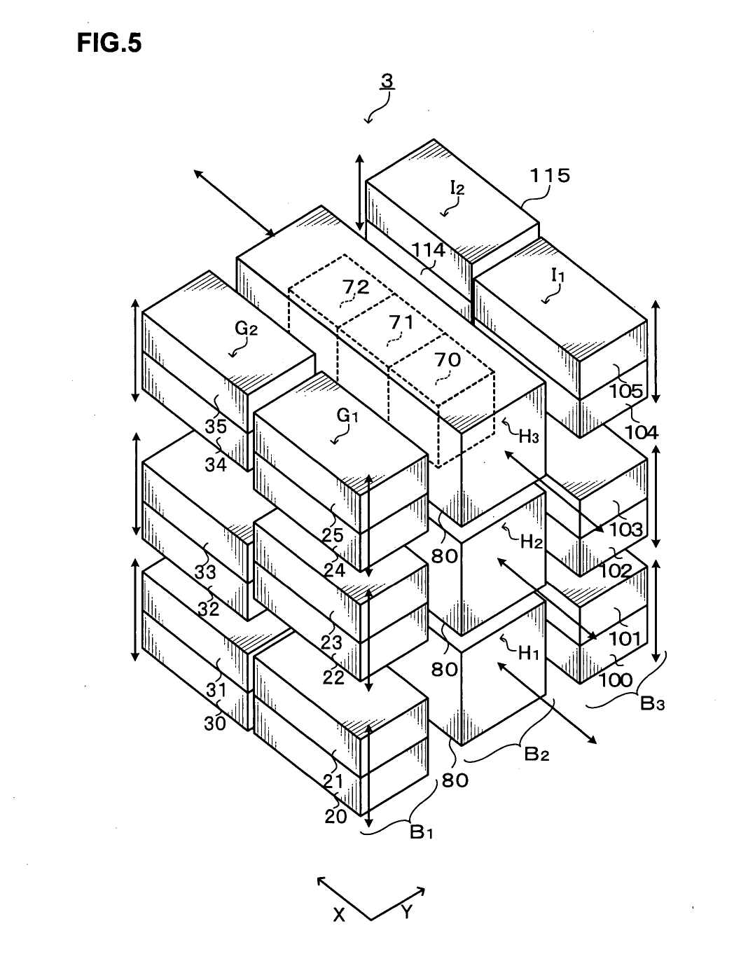

As described above, in the processing station 3, the thermal processing units in the first block B1 and the thermal processing units in the third block B3 can vertically move as shown in FIG. 5. Further, the solution treatment units in the second block B2 can move horizontally in the X-direction as a unit in the housing 80 in each of the layers H1 to H3. In the thermal processing units in the first block B1 and the third block B3, the wafer carriers 28 are provided for carrying the wafers W to/from the solution treatment units in the second block B2. This configuration enables the units in the adjacent blocks to move relative to each other and to carry the wafers W, within their movable ranges, between an arbitrary unit in first block B1 and that in the second block B2, and between an arbitrary unit in the second block B2 and that in the third bock B3.

On the processing station 3 side in the interface section 4, for example, a wafer carrier 150 is provided as shown in FIG. 1. On the positive direction side in the Y-direction in the interface section 4, edge exposure units 151 and 152 each for selectively exposing only the edge portion of the wafer W, and a transfer cassette 153 for transferring the wafer W to/from the aligner (not shown) are provided side by side in the X-direction. The transfer cassette 153 is provided between the edge exposure units 151 and 152.

The wafer carrier 150 is movable on a carrier path 154 extending, for example, in the X-direction. The wafer carrier 150 has a supporting portion 150a for supporting the wafer W, the supporting portion 150a being movable in the vertical direction and movable back and forth in the horizontal direction. The wafer carrier 150 can access the thermal processing units in the third block B3 in the processing station 3, the edge exposure units 151 and 152, and the transfer cassette 153, and carry the wafer W to them.

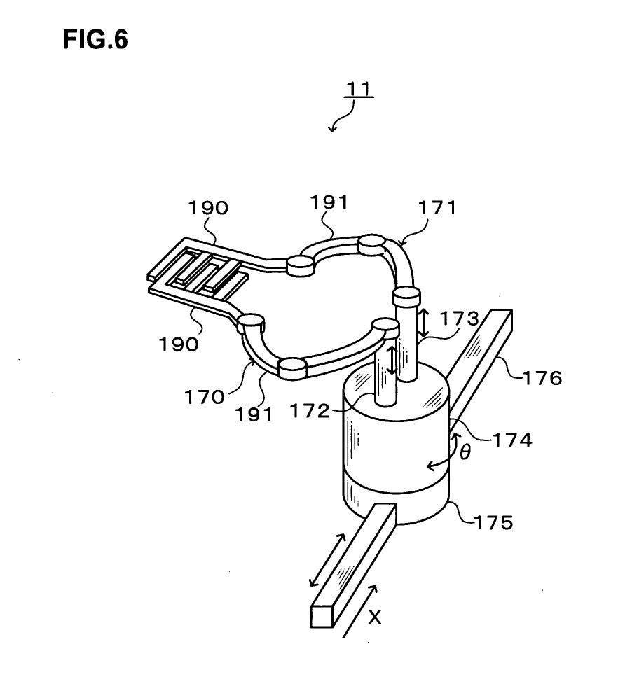

The configuration of the carrier 11 in the cassette station 2 will be described here in detail. FIG. 6 is a perspective view showing the outline of the configuration of the carrier 11.

The carrier 11 includes, for example, two multi-joint carrier arms 170 and 171, rising and lowering shafts 172 and 173 to which the carrier arms 170 and 171 are attached respectively, a rotary table 174 to which the rising and lowering shafts 172 and 173 are secured, a base 175 to which the rotary table 174 is attached, and a rail 176 on which the base 175 moves.

The rail 176 is formed along the X-direction, for example, on the floor of the cassette station 2. The base 175 can move in the X-direction on the rail 176, for example, by means of a drive source such as a motor provided therein.

The rotary table 174 is formed, for example, in a cylindrical form. The rotary table 174 can rotate in a direction about the vertical central axis (θ-direction), for example, by means of a drive source such as a motor provided therein.

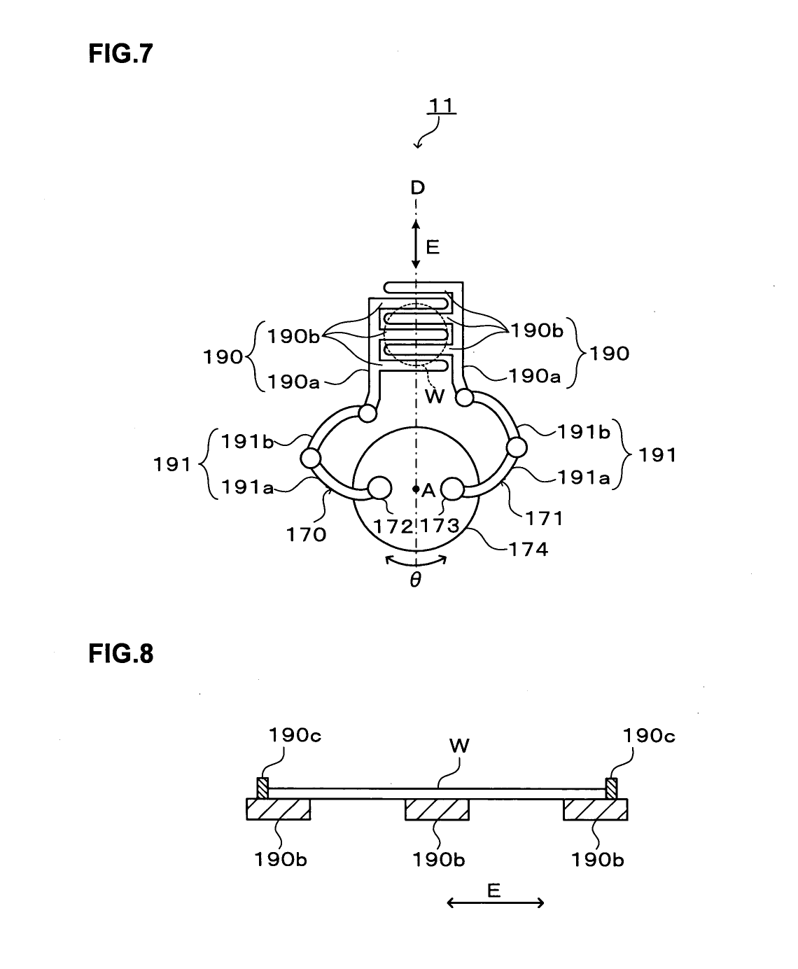

The rising and lowering shafts 172 and 173 are provided on the rotary table 174. The rising and lowering shafts 172 and 173 are located at positions displaced from a rotation axis A of the rotary table 174 in plan view and apart by equal distance from the rotation axis A as shown in FIG. 7. Further, the rising and lowering shafts 172 and 173 are located at positions axisymmetrical with respect to a carriage axis D passing through the rotation axis A in a carriage direction E of the wafer W. The rising and lowering shafts 172 and 173 can expand and contract in the vertical direction, for example, by means of respective drive sources such as cylinders provided in the rotary table 174. The rising and lowering shafts 172 and 173 can rise and lower independently of each other.

The carrier arm 170 includes, for example, a wafer support portion 190 and an arm portion 191 connecting the wafer support portion 190 and the rising and lowering shaft 172.

The wafer support portion 190 is formed in the shape of a comb including, for example, a base portion 190a in the shape of an elongated flat plate along the carriage direction E in the horizontal direction, and a plurality of projecting portions 190b formed projecting from the base portion 190a toward in one direction on the carriage axis D side. The projecting portions 190b are formed in the shape of elongated flat plates and formed at predetermined intervals on the side surface of the base portion 190a. The wafer support portion 190 can support the wafer W on the projecting portions 190b arranged side by side. As shown in FIG. 8, for example, on the projecting portions 190b at the front side and at the rear side, retaining members 190c are provided which retain the wafer W from the front side and the rear side.

The arm portion 191 includes, for example, two connecting arms 191a and 191b rotatably connected to each other as shown in FIG. 7. The first connecting arm 191a is rotatably connected to the rising and lowering shaft 172, and the second connecting arm 191b is rotatably connected to the end of the base portion 190a of the wafer support portion 190. The arm portion 191 can, for example, rotate the shafts of the connecting portions in conjunction with each other to linearly move the wafer support portion 190 in the forward and backward direction (carriage direction) E to thereby carry the wafer W on the wafer support portion 190 along the carriage axis D. The arm portion 191 is curved convexly outward in a direction perpendicular to the carriage direction E in plan view. This allows a large space to be kept on the backside of the wafer support portion 190.

The carrier arm 171 has the same configuration as that of the carrier arm 170, and they are arranged symmetrical with respect to the carriage axis D in plan view. The carrier arm 171 is attached to the rising and lowering shaft 173. The carrier arm 171 can move the wafer support portion 190 supporting the wafer W in the forward and backward direction E to thereby carry the wafer W along the carriage axis D. The carrier arm 171 has a carriage path of the wafer W overlapped on that of the carrier arm 170 in plan view.

The wafer support portions 190 of the carrier arm 170 and the carrier arm 171 are arranged such that their projecting portions 190b face each other in plan view. The projecting portions 190b of the wafer support portions 190 can be fitted in each other without interfering with each other. More specifically, the projecting portions 190b of one of the wafer support portions 190 can pass through the gaps between the projecting portions 190b of the other wafer support portion 190. This allows the wafer support portions 190 of the carrier arms 170 and 171 to pass each other without interfering with each other, with positions of their projecting portions 190b displaced with respect to each other.

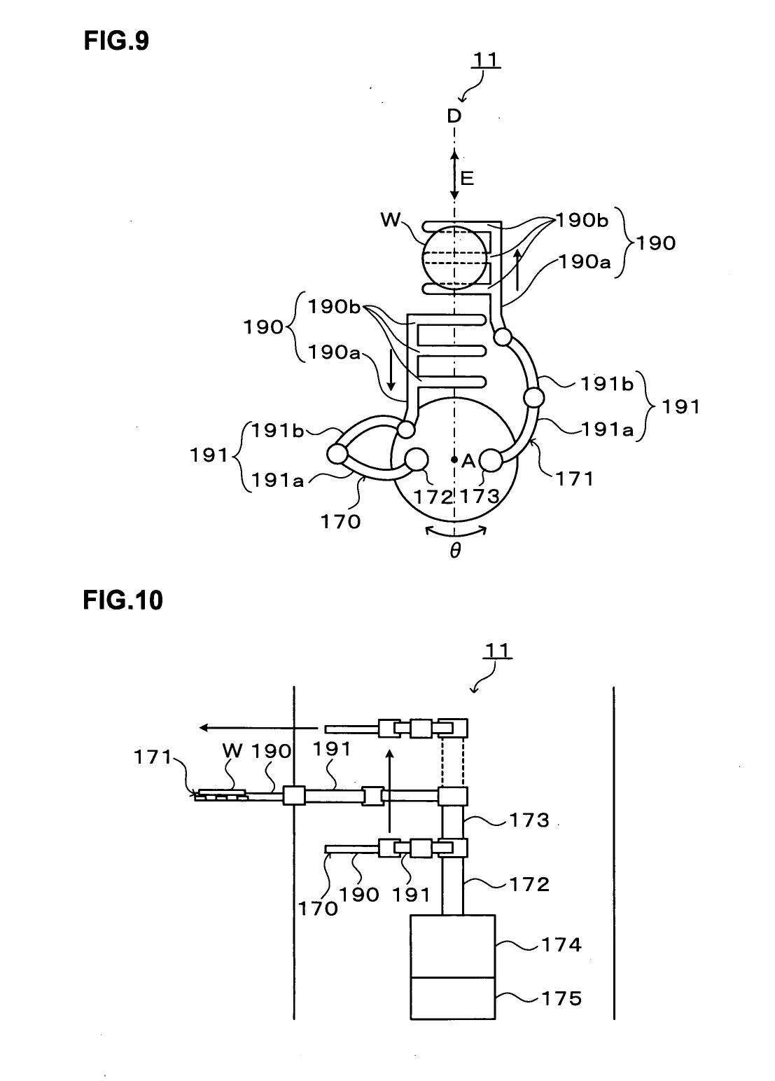

As shown in FIG. 9, when the wafer support portion 190 of one of the carrier arms 170 moves forward, a space can be formed on the backside of that wafer support portion 190, so that the wafer support portion 190 of the other carrier arm 171 can vertically pass through the space. In other words, each of the carrier arms 170 and 171 can pass the other.

Next, the operation of the carrier 11 configured as described above will be described together with the processing process for the wafer W performed in the substrate processing system 1.

First of all, an unprocessed wafer W in the cassette C is carried by the carrier 11 into the first block B1 in the processing station 3 as shown in FIG. 1. The wafer W is carried, for example, to the adhesion/cooling unit 25 in the first unit group G1 as shown in FIG. 2.

For example, the wafer W carried into the adhesion/cooling unit 25 is first adjusted to a predetermined temperature by the cooling plate 27 and then carried from the cooling plate 27 to the heating plate 26. The wafer W is heated to a predetermined temperature on the heating plate 26 and coated with vapor of HMDS. Thereafter, the wafer W is returned to the cooling plate 27 and carried by the wafer carrier 28 to, for example, the resist coating unit 70 or 72 in the third unit layer H3 on the upper tier in the second block B2.

At the time of carriage, if the carriage destination, for example, the resist coating unit 70, and the adhesion/cooling unit 25 are not aligned, the adhesion/cooling unit 25 moves vertically as shown in FIG. 2 or the resist coating unit 70 moves horizontally as shown in FIG. 1, whereby the adhesion/cooling unit 25 and the resist coating unit 70 move relative to each other so that the resist coating unit 70 exists within the range where the wafer carrier 28 can carry the wafer W.

The wafer W carried, for example, into the resist coating unit 70 is coated with a resist solution. The wafer W is then carried from the resist coating unit 70, for example, to the heating/cooling unit 24 on the upper tier side in the first unit group G1 in the first block B1 as shown in FIG. 2. The carriage of the wafer W is performed by the wafer carrier 28 of the heating/cooling unit 24 after the resist coating unit 70 and the heating/cooling unit 24 move relative to each other.

The wafer W carried, for example, into the heating/cooling unit 24 is carried from the cooling plate 27 to the heating plate 26 and pre-baked. When the pre-baking is finished, the heating/cooling unit 24 and, for example, the top coating unit 60 in the second unit layer H2 in the second block B2 move relative to each other, and the wafer W is then carried by the wafer carrier 28 to the top coating unit 60.

The wafer W carried, for example, into the top coating unit 60 is coated with an antireflection solution, whereby an antireflection film is formed thereon. Thereafter, the top coating unit 60 and, for example, the heating/cooling unit 102 at the intermediate tier in the first unit group I1 in the third block B3 move relative each other, and the wafer W is then carried from the top coating unit 60 to the heating/cooling unit 102.

The wafer W carried, for example, into the heating/cooling unit 102 is heated. The wafer W for which heating has been finished is then carried, for example, to the edge exposure unit 151 shown in FIG. 1 by the wafer carrier 150 in the interface section 4. In the edge exposure unit 151, the outer peripheral portion of the wafer W is exposed. The wafer W is then carried by the wafer carrier 150 to the transfer cassette 153 and to the aligner (not shown) close to the interface section 4, where the wafer W is exposed.

The wafer W for which the exposure processing has been finished is returned into the transfer cassette 153 and carried by the wafer carrier 150, for example, to the heating/cooling unit 100 on the lower tier side in the first unit group I1 in the third block B3 as shown in FIG. 2. The wafer W carried, for example, into the heating/cooling unit 100 is carried from the cooling plate 27 to the heating plate 26 where the wafer W is subjected to post-exposure baking.

When the post-exposure baking is finished, for example, the heating/cooling unit 100 and, for example, the developing treatment unit 50 in the first unit layer H1 in the second block B2 move relative each other, and the wafer W is then carried by the wafer carrier 28 to the developing treatment unit 50.

The wafer W carried, for example, into the developing treatment unit 50 is developed. When the developing treatment is finished, the developing treatment unit 50 and, for example, the heating/cooling unit 20 in the first unit group G1 in the first block B1 move relative each other, and the wafer W is then carried by the wafer carrier 28 to the heating/cooling unit 20.

The wafer W carried, for example, into the heating/cooling unit 20 is heated to be subjected to post-baking. The wafer W for which the post-baking has been finished is returned to the cassette C by the carrier 11 in the cassette station 2. Thus, a series of processes of photolithography end.

Subsequently, the operation of the carrier 11 will be described. For example, when an unprocessed wafer W is carried from the cassette C in the cassette station 2 to the unit in the processing station 3 as shown in FIG. 2, the carrier 11 moves in the X-direction along the rail 176 to move, for example, to the front side of the cassette C being the carriage source. Subsequently, the carrier arms 170 and 171 are adjusted to predetermined heights by the rising and lowering shafts 172 and 173, respectively. Then, the carrier arms 170 and 171 expand to the cassette C side to cause the wafer support portions 190 to move forward and hold wafers W in the cassette C, respectively. Thereafter, the carrier arms 170 and 171 contract to cause the wafer support portions 190 to move backward and return to their original positions. Next, the rotary table 174 rotates to orient the carrier arms 170 and 171 toward the processing station 3 side. Subsequently, the heights of the carrier arms 170 and 171 are adjusted. For example, the carrier arm 170 expands to the processing station 3 side to cause the wafer support portion 190 to move forward and carry the wafer W, for example, to the unit in the first block B1 being the carriage destination. Subsequently, the carrier arm 171 similarly carries the wafer W to the unit in the first block B1 being the carriage destination.

When the processed wafers W are carried from the units in the processing station 3 to the cassette C in the cassette station 2, the carrier arms 170 and 171 of the carrier 11 first similarly move to the front side of the units being the carriage sources in the first block B1. Then, the carrier arms 170 and 171 cause the wafer support portions 190 to move forward and hold the wafers W in the units, respectively. Thereafter, the carrier arms 170 and 171 cause the wafer support portions 190 to move backward to their original positions. The rotation of the rotary table 174 orients the carrier arms 170 and 171 toward the cassette station 2 side. The carrier arms 170 and 171 expand to the cassette C side being the carriage destination to cause the wafer support portions 190 to move forward and carry the wafers W into the cassette C.

In the case where in the above-described carriage of the wafer W between the cassette station 2 and the processing station 3, for example, the carrier arm 170 located on the lower side as shown in FIG. 10 carries the wafer W to a position higher than the carrier arm 171 located on the upper side, for example, while the carrier arm 171 is expanding to cause the wafer support portion 190 to move forward, the carrier arm 170 is raised to allow the wafer support portion 190 of the carrier arm 170 to pass through the space on the backside of the wafer support portion 190 of the carrier arm 171 as shown in FIG. 9 and FIG. 10. Thus, the carrier arm 170 can pass the carrier arm 171 and carry the wafer W to the carriage destination located above the carrier arm 171.

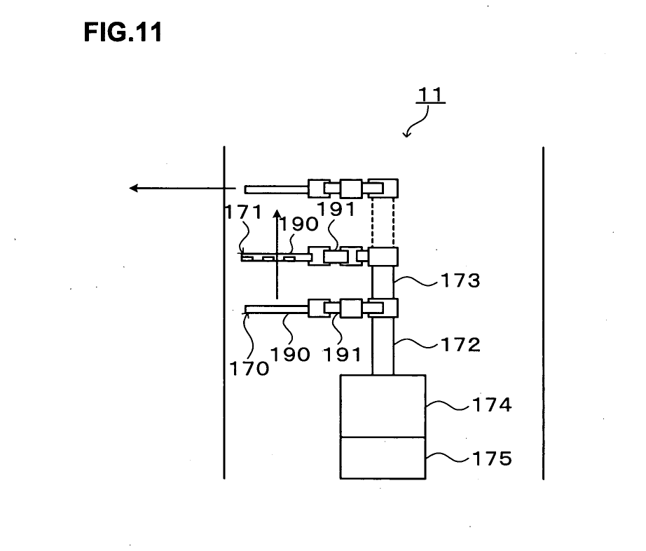

If both of the carrier arms 170 and 171 hold no wafer W, the wafer support portions 190 are nearly aligned with each other in the forward and backward direction E in plan view, and the carrier arm 170 is then raised as shown in FIG. 11. Then, the projecting portions 190b of one of the wafer support portions 190 are allowed to pass through the gaps between the projecting portions 190b of the other wafer support portion 190 as shown in FIG. 7, whereby the wafer support portions 190 pass each other so that the carrier arm 170 moves to a position above the carrier arm 171. This movement also allows the carrier arm 170 to pass the carrier arm 171 and carry the wafer W to the destination above the carrier arm 171. Note that the carrier arm 171 can also pass the carrier arm 170 in the similar manner.

According to the above embodiment, each of the carrier arms 170 and 171 of the carrier 11 can pass the other, so that the degrees of freedom of movements of the carrier arms 170 and 171 can be increased without interference of the movements of the carrier arms 170 and 171 in the vertical direction. This can decrease the limitation to the movements of the carrier arms 170 and 171, thereby simplifying control of the movements of the carrier arms 170 and 171. Further, the carriage efficiency of the wafers W carried by the carrier arms 170 and 171 in the substrate processing system 1 can also be increased.

When the wafer support portion 190 of one of the carrier arms is moved forward, a space is formed on the backside of that wafer support portion 190 through which the wafer support portion 190 of the other carrier arm can pass. Accordingly, each of the carrier arms 170 and 171 can appropriately pass the other, for example, even when the carrier arms 170 and 171 support the wafers W.

Furthermore, since the arm portions 191 of the carrier arms 170 and 171 are curved convexly outward, it is possible to surely prevent interference of the wafer support portion 190 and the arm portion 191 when each of the carrier arms 170 and 171 passes the other.

Since each of the wafer support portions 190 of the carrier arms 170 and 171 is formed in the shape of a comb including the base portion 190a and the plurality of projecting portions 190b and the wafer support portions 190 can pass each other without interfering with each other, each of the carrier arms 170 and 171 can pass the other even though the wafer support portion 190 of one of the carrier arms is not moved forward. As a result of this, the degrees of freedom of the movements of the carrier arms 170 and 171 can be further increased.

A preferred embodiment of the present invention has been described above with reference to the accompanying drawings, but the present invention is not limited to the embodiment. It should be understood that various changes and modifications are readily apparent to those skilled in the art within the spirit as set forth in claims, and those should also be covered by the technical scope of the present invention.

For example, while each of the wafer support portions 190 of the carrier arms 170 and 171 has the shape of a comb in the above-described embodiment, other shapes may be employed as long as they allow the carrier arms to pass each other. For example, the number of projecting portions 190b of the wafer support portion 190 is not limited to three, but any number may be selected. Further, the shape of the base portion 190a and the projecting portion 190b of the wafer support portion 190 is not limited to a flat plate shape, and may be, for example, a rod shape because they are only required to support the wafer W.

The number of the carrier arms is two in the above embodiment, but may be three or more. In this case, it is not necessary that every one of the plurality of carrier arms is capable of passing the other, and specific carrier arms of the plurality of carrier arms are capable of passing each other. While the carrier arms 170 and 171 are of the multi-joint type and expand and contract to cause the wafer support portions 190 in the forward and backward direction in the above-described embodiment, any carrier arm may be employed which has no joint so that the whole carrier arm moves back and forth as one body.

Furthermore, while the carrier arms 170 and 171 rotate in the θ-direction by means of the common rotary table 174 in the above-described embodiment, they may be designed such that each of them can be independently rotated. In this case, for example, the rising and lowering shafts 172 and 173 may be capable of rotating in the O-direction.

While the present invention is applied, for example, to the carrier 11 in the cassette station 2 of the substrate processing system 1 in the above-described embodiment, the present invention may also be applied to the wafer carrier 150 in the interface section 4.

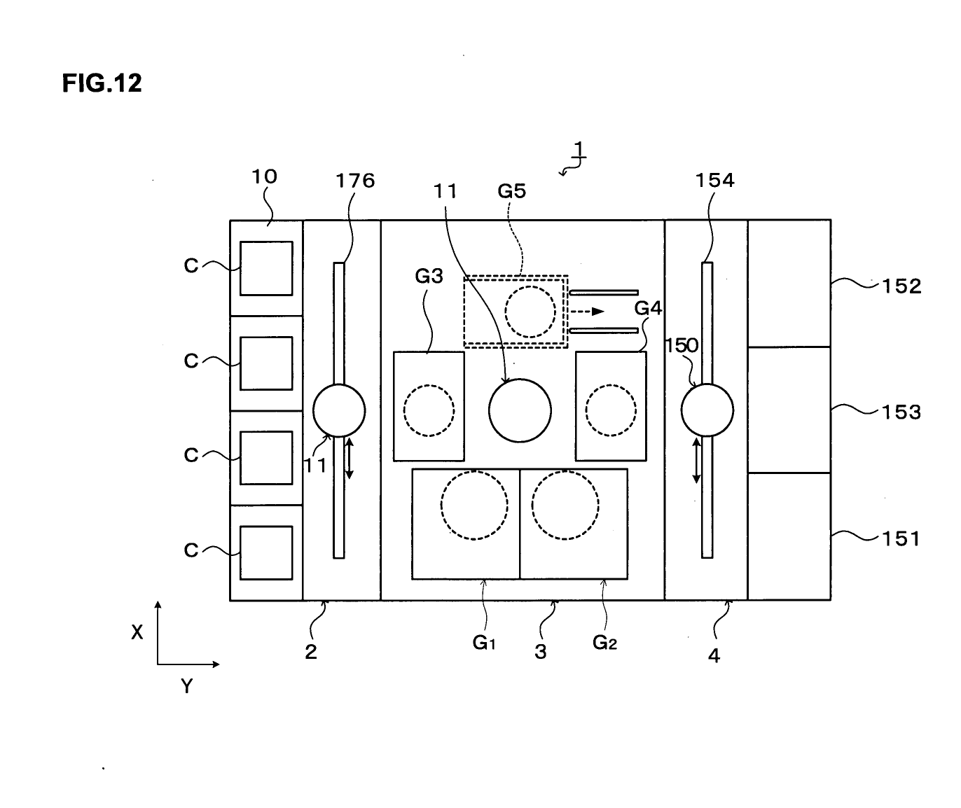

While the units move relative to each other to carry the wafer W in the processing station 3 of the above-described embodiment, the carrier 11 of the present invention may be installed in the processing station 3, so that the carrier 11 is used to carry the wafer W between the units. In this case, as shown in FIG. 12, the carrier 11 of the present invention may be located, for example, at the center of the processing station 3 and the plurality of unit groups G1 to G5 in which the processing units are multi-tiered may be arranged around the carrier 11. In this case, since each of the carrier arms 170 and 171 of the carrier 11 can pass the other, carriage of a plurality of wafers W between the units in the processing station 3 can be efficiently performed. Furthermore, the present invention is also applicable to a carrier for carrying other substrates such as an FPD (Flat Panel Display), a mask reticle for a photomask, and the like other than the wafer W.

The present invention is useful in increasing the degrees of freedom of movements of a plurality of carrier arms in a carrier for carrying a substrate.

What is claimed is:

1. A carrier for carrying a substrate, comprising:
a plurality of carrier arms provided close to each other, each of said carrier arms for supporting the substrate and carrying the substrate in the horizontal direction,
wherein said plurality of carrier arms are arranged such that carriage paths thereof overlap one on the other in plan view, each of said paths for horizontally carrying-in/out the substrate to/from a processing unit or a substrate housing cassette, and
wherein each of said plurality of carrier arms is independently movable in the vertical direction and is capable of passing the other in the vertical direction at a position on the carriage path.

2. The substrate carrier as set forth in claim 1,
wherein said carrier arm comprises a substrate support portion for supporting the substrate and moves said substrate support portion in a forward and backward direction on the carriage path of the substrate to carry-in/out the substrate to/from the processing unit or the substrate housing cassette, and
wherein when said substrate support portion of one of said carrier arms moves forward, a space is formed on the backside of said substrate support portion of the one carrier arm, through the space the other carrier arm being capable of passing in the vertical direction.

3. The substrate carrier as set forth in claim 2,
wherein said substrate support portions of said carrier arms are configured such that said substrate support portions supporting no substrate are capable of passing each other in the vertical direction without interfering with each other at a same position on the carriage paths in plan view, each of said paths for carrying-in/out the substrate to/from the processing unit or the substrate housing cassette.

4. The substrate carrier as set forth in claim 3,
wherein said plurality of carrier arms comprise two carrier arms,
wherein said substrate support portion comprises a base portion extending in the forward and backward direction and a plurality of projecting portions projecting in one direction from a side surface of said base portion,
wherein said plurality of projecting portions are provided having gaps intervening therebetween on the side surface of said base portion,
wherein said substrate support portions of said carrier arms are arranged such that said projecting portion sides face each other in plan view, and
wherein when passing each other in the vertical direction, said projecting portions of one of said substrate support portions pass through the gaps between said projecting portions of the other substrate support portion.

5. The substrate carrier as set forth in claim 2,
wherein said carrier arms are attached to discrete rising and lowering shafts for vertically moving said carrier arms.

6. The substrate carrier as set forth in claim 5,
wherein each of said carrier arms has an arm portion connecting said substrate support portion and said rising and lowering shaft, and
wherein said arm portion is curved convexly outward in a direction perpendicular to the forward and backward direction in which said substrate support portion moves in plan view.

7. The substrate carrier as set forth in claim 5,
wherein said rising and lowering shafts of said carrier arms are attached to a same rotary table rotatable around an axis in the vertical direction.

8. The substrate carrier as set forth in claim 7,
wherein said rotary table is movable in the horizontal direction.

9. The substrate carrier as set forth in claim 4,
wherein said substrate support portion is in a shape of a comb.

10. The substrate carrier as set forth in claim 2,
wherein while said substrate support portion of one of said carrier arms is carrying-in/out the substrate to/from the processing unit or the substrate housing cassette, the other carrier arm passes through the space to pass the one carrier arm in the vertical direction.

11. The substrate carrier as set forth in claim 2,
wherein said carrier carries the substrate between the processing unit and the substrate housing cassette.

12. The substrate carrier as set forth in claim 2,
wherein said carrier carries the substrate between the processing unit and another processing unit.

13. The substrate carrier as set forth in claim 7,
wherein said carrier arms are arranged at positions symmetrical with respect to a carriage axis passing through the rotation axis of said rotary table and the carriage paths.
